(19) United States
(12) Patent Application Publication
(10) Pub. No.: US 2015/0221328 A1
(43) Pub. Date: Aug. 6, 2015

(54) MAGNETIC READ SENSOR WITH BAR SHAPED AFM AND PINNED LAYER STRUCTURE AND SOFT MAGNETIC BIAS ALIGNED WITH FREE LAYER

(71) Applicant: HGST Netherlands B.V., Amsterdam (NL)

(72) Inventors: Quang Le, San Jose, CA (US); Simon H. Liao, Fremont, CA (US); Guangli Liu, Pleasanton, CA (US); Stefan Maat, San Jose, CA (US); Shuxia Wang, San Jose, CA (US)

(73) Assignee: HGST NETHERLANDS B.V., Amsterdam (NL)

(21) Appl. No.: 14/170,495

(22) Filed: Jan. 31, 2014

(51) Int. Cl. G11B 5/39

(52) U.S. Cl. CPC G11B 5/3932; G11B 2005/3996

(57) ABSTRACT

A magnetic sensor having a structure that optimizes magnetic pinning strength and magnetic free layer stability. The sensor includes a sensor stack having a magnetic free layer that extends to a first stripe height and a pinned layer that extends beyond the first stripe height to a second stripe height. Magnetic bias structures are formed at the sides of the free layer and are each formed upon a non-magnetic fill layer that raises the bias layer to the level of the free layer, the non-magnetic fill layer being at the level of the pinned layer in the sensor stack. The fill layer allows the free layer stripe height to be defined in a partial mill process while allowing the pinned layer to extend beyond the free layer stripe height and also advantageously allows the bias layers to have a stripe height that is aligned with the free layer stripe height.

### FIELD OF THE INVENTION

The present invention relates to magnetic data recording and more particularly to a magnetic sensor having shape optimized bias structure and a shape optimized extended pinned layer structure with recessed AFM.

### BACKGROUND

At the heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has a media facing surface (MFS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When current flows through the coil, a resulting magnetic field causes a magnetic flux to flow through the coil, which results in a magnetic write field emitting from the tip of the write pole. This magnetic field is sufficiently strong that it locally magnetizes a portion of the adjacent magnetic media, thereby recording a bit of data. The write field then, travels through a magnetically soft under-layer of the magnetic medium to return to the return pole of the write head.

A magnetoresistive sensor such as a Giant Magnetoresistive (GMR) sensor or a Tunnel Junction Magnetoresistive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the magnetic media.

As sensors become ever smaller in order to accommodate increased data density requirements, certain important parameters become ever more difficult to maintain, especially in light of manufacturing limitations. For example, maintaining robust pinning of a pinned layer structure becomes more difficult. Similarly, it becomes more difficult to maintain good free layer stability. Therefore, there remains a need for a magnetic sensor design, and method of manufacture thereof, that can maintain good pinned layer and free layer stability at very small sensor dimensions.

### SUMMARY

What is provided is a magnetic sensor that has a free magnetic layer extending to a first stripe height, measured from a media facing surface, a pinned magnetic layer extending beyond the first stripe height to a second stripe height measured from the media facing surface, and a non-magnetic layer sandwiched between the free magnetic layer and the pinned magnetic layer. A magnetic bias structure is formed at a side of the sensor stack, the bias structure extending to the first stripe height and formed on a non-magnetic fill layer so that it is aligned with the magnetic free layer.

The presence of the non-magnetic fill layer advantageously allows the back edge of the free layer and back edge of the bias structure to be defined by a common masking an milling operation so that they can be self aligned while also allowing the pinned layer structure to extend beyond the free layer stripe height. This also allows the pinned layer structure to have a substantially constant width, the pinned layer structure being formed in a generally rectangular prism shape.

The sensor can be formed by a process that includes, depositing a plurality of sensor layers including a magnetic pinned layer structure, a non-magnetic layer deposited over the magnetic pinned layer structure and a magnetic free layer structure deposited over the magnetic pinned layer structure. A first mask is formed having a width configured to define a sensor track width, and a first ion milling is performed to remove portions of the plurality of sensor layers that are not protected by the mask. A non-magnetic, electrically insulating fill layer is deposited, followed by a magnetic bias material deposited over the non-magnetic, electrically insulating fill layer. A second mask is formed that is configured to define a magnetic free layer stripe height, and a second ion milling is performed to remove portions of the magnetic free layer that are not protected by the second mask, the second ion milling being terminated prior to removal of the magnetic pinned layer structure.

These and other features and advantages of the invention will be apparent upon reading of the following detailed description of the embodiments taken in conjunction with the figures in which like reference numeral indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is a media facing surface view of a slider illustrating the location of a magnetic head thereon;

FIG. 3 is a media facing surface view of a magnetic read sensor;

FIG. 4 is a side cross sectional view taken from the center of the sensor as seen from line 4-4 of FIG. 3;

FIG. 5 is a side cross sectional view of an outer portion of the magnetic sensor as seen from line 5-5 of FIG. 3; and

FIGS. 6-17 are views of a magnetic sensor in various intermediate stages of manufacture, illustrating a method of manufacturing a magnetic sensor according to an embodiment of the invention.

### DETAILED DESCRIPTION

The following description is of the best embodiments presently contemplated for carrying out this invention. This description is made for the purpose of illustrating the general principles of this invention and is not meant to limit the inventive concepts claimed herein.

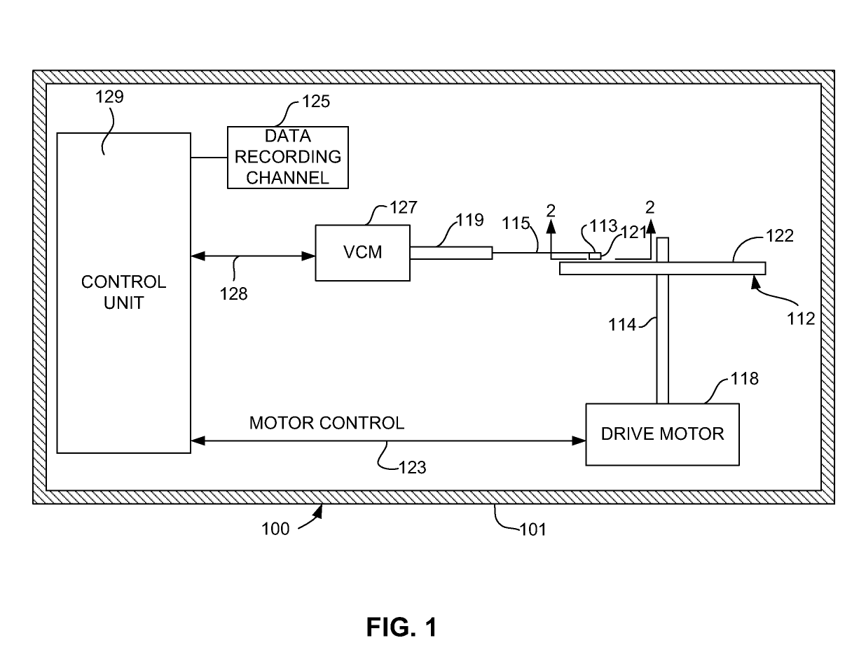

Referring now to FIG. 1, there is shown a disk drive 100. The disk drive 100 includes a housing 101. At least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk 112 rotates, slider 113 moves in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases the slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by the controller 129.

During operation of the disk storage system, the rotation of the magnetic disk 112 generates an air bearing between the slider 113 and the disk surface 122, which exerts an upward force or lift on the slider. The air bearing thus counter-balances the slight spring force of the suspension 115 and supports the slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage, means and a microprocessor. The control unit 129 generates control signals to control various system operations such as drive motor control signals on line 123 and head position and seek control signals on line 128. The control signals on line 128 provide the desired current profiles to optimally move and position the slider 113 to the desired data track on the media 112. Write and read signals are communicated to and from write and read heads 121 by way of recording channel 125.

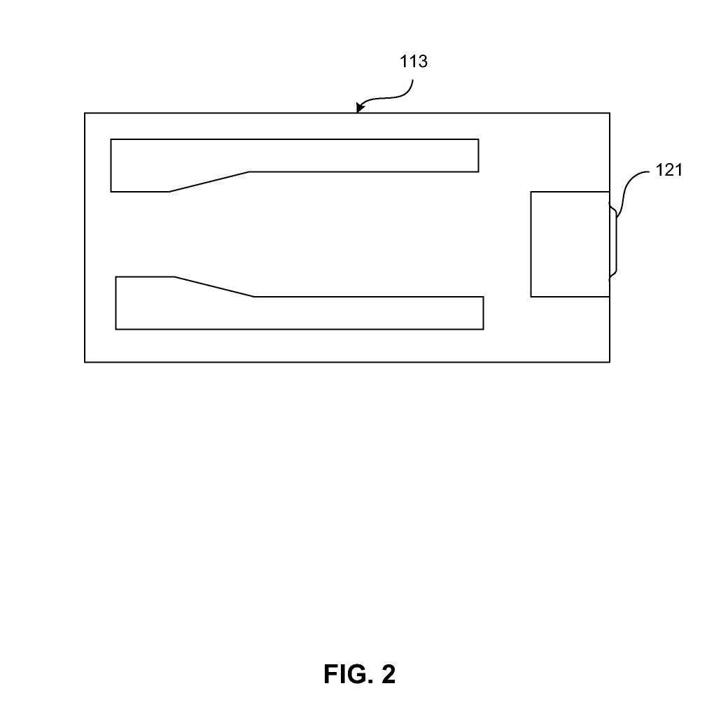

With reference to FIG. 2, the orientation of the magnetic head 121 in a slider 113 can be seen in more detail. FIG. 2 is a media facing surface view of the slider 113, and as can be seen, the magnetic head 121, including an inductive write head and a read sensor, is located at a trailing edge of the slider 113. The above description of a typical magnetic disk storage system and the accompanying illustration of FIGS. 1 and 2 are for representation purposes only. It should be apparent that the disk storage system may contain a large number of disks and actuators, and each actuator may support a number of sliders.

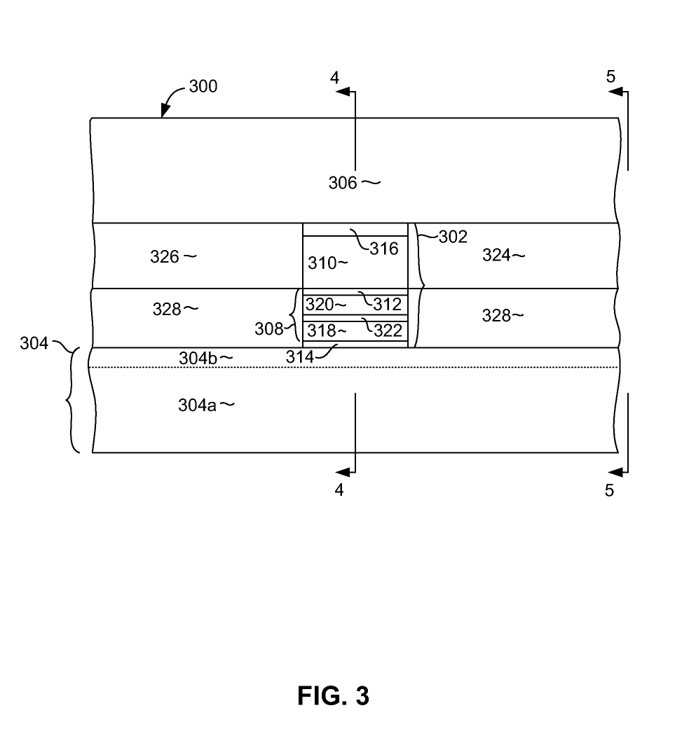

FIG. 3 shows a magnetic read head 300 as viewed from the media facing surface. The sensor 300 includes a sensor stack 302 that is sandwiched between upper and lower magnetic shields 304, 306. The lower shield includes a main magnetic shield portion 304a and a refill portion 304b, which will be described in greater detail herein below.

The sensor stack 302 includes a magnetic pinned layer structure 308, a magnetic free layer structure 310 and a non-magnetic spacer or barrier layer 312 sandwiched between the pinned layer structure 308 and free layer structure 310. If the sensor 300 is a giant magnetoresistive (GMR) sensor, then the layer 312 can be a non-magnetic, electrically conductive spacer layer such as AgSn. If the sensor 300 is a tunnel junction magnetoresistive sensor (TMR) then the layer 312 can be a thin, non-magnetic, electrically insulating barrier layer such as MgO.

The sensor stack 302 can also include a seed layer 314 at its bottom to promote a desired crystalline growth in the layers deposited over it. In addition, the sensor stack 302 can include a capping layer 316 that protects the layers of the sensor stack during manufacture and magnetically de-couples the magnetic free layer from the upper magnetic shield 306. The pinned layer structure 308 can further include a first magnetic layer (AP1) 318, a second magnetic layer (AP2) 320 and a non-magnetic, antiparallel coupling layer such as Ru 322 sandwiched between the AP1 and AP2 layers 318, 322.

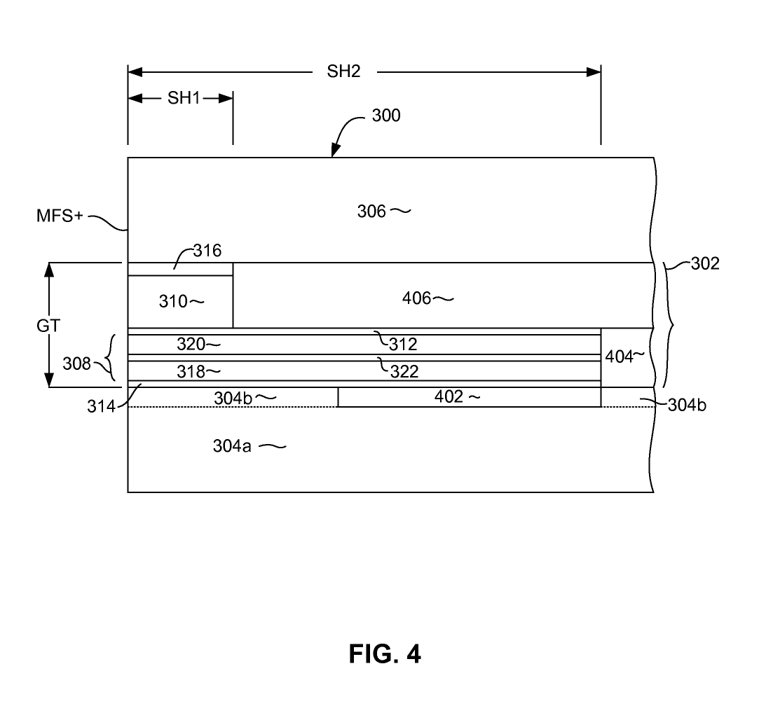

FIG. 4 shows a side, cross sectional view as seen from line 4-4 of FIG. 3. As seen in FIG. 4, the sensor 300 includes a layer of antiferromagnetic material (AFM layer) 402 such as IrMn or PtMn that is embedded within the lower shield fill 304b. The AFM layer is exchange coupled with the AP1 layer 318, which pins the magnetization of the AP1 318 in a first direction that is perpendicular with the media facing surface (MFS). Anti-parallel coupling between the AP1 layer 318 and AP2 layer 320 pins the magnetization of the AP2 layer 320 in a second direction that is perpendicular to the MFS and opposite to the magnetization of the AP1 layer 318.

As can be seen, the AFM 402 not only embedded in the first shield fill layer 304b, but is also recessed from the MFS. This advantageously allows the AFM layer 402 to provide strong pinning, while also not contributing to the magnetic gap thickness GT of the sensor 300, thereby providing reduced bit length and increased magnetic data density.

In addition, it can be seen in FIG. 4, that the free layer 310 extends to a first stripe height (SH1) whereas the pinned layer structure 308 extends beyond the free layer 310 to a second stripe height SH2, both SH1 and SH2 being measured from the media facing surface MFS. The space behind the pinned layer structure 308 can be filled with a non-magnetic, electrically insulating fill layer 404, and the space behind the free layer 310 and capping layer 316 can be filled with another non-magnetic, electrically insulating fill layer 406. It should be pointed out that the pinned layer has a width (track width TW) that is the same as that of the free layer 310 as shown in FIG. 3, and this width TW of the pinned layer structure 308 is constant all of the way to the second stripe height SH2 (FIG. 4). Therefore, the pinned layer structure 308 can be said to have a bar shape that is substantially in the shape of a rectangular prism. This narrow, deep shape provides a shape enhanced magnetic anisotropy that further assists pinning robustness.

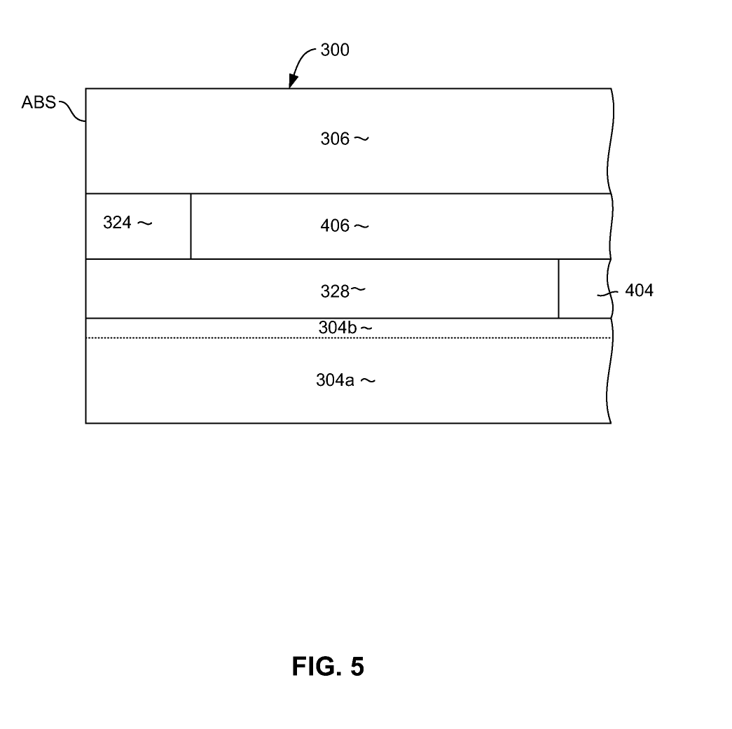

With reference again to FIG. 3, the sensor 300 has first and second magnetic bias structures 324, 326, that extend from the sides of the magnetic free layer 310. It can also be seen that the bias layers 324, 236 are formed on top of a non-magnetic fill layer 328 that raises the bias layers to the level of the free layer 310 but above the pinned layer structure 308. The fill layer 328 can be a material such as alumina. FIG. 5 shows a side cross sectional view of an outer portion of the sensor 300 as seen from line 5-5 of FIG. 3. As seen in FIG. 5, the bias layer 324 has a back edge that extends to the first stripe height SH1. Therefore, the bias layers (and 326 not shown in FIG. 5) each have a stripe height that is self aligned with that of the free layer. The presence of the under-lying fill layer 328 makes this possible, while also allowing the pinned layer structure 308 (FIGS. 3 and 4) to have the extended rectangular prism shape described above. The reason for this will become clearer after reading the following description of a method for manufacturing a magnetic read sensor such as the sensor 300 described above.

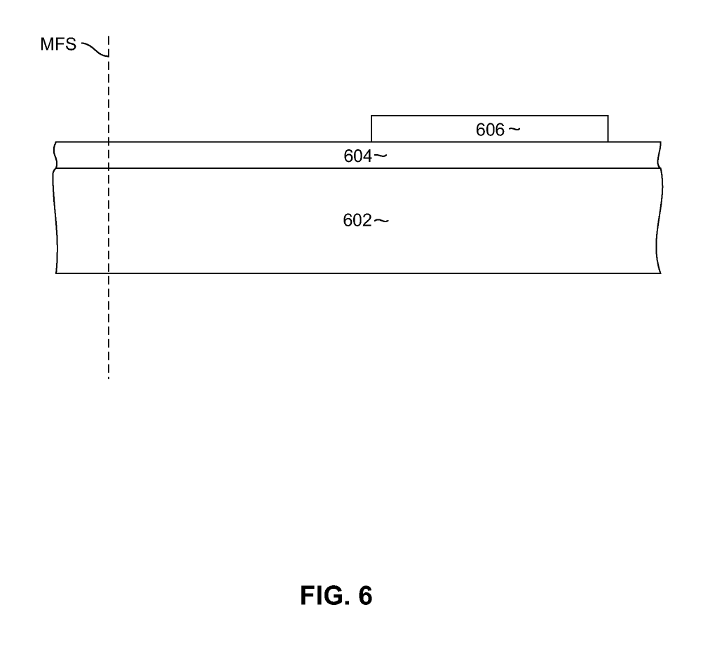

With reference now to FIGS. 6-17 a method is described for manufacturing a magnetic sensor such as that described above. With particular reference to FIG. 6, a lower main magnetic shield portion 602 is formed of a material such as NiFe. Then, a layer of anti-ferromagnetic material (AFM layer) 604 and first part of layer 318a capped with MgO, are deposited over the main magnetic shield portion 602. The AFM layer 604 can be a material such as IrMn or PtMn. Then, a mask 606 is formed over the AFM layer 604 with first part of layer 318a capped with MgO. The mask is configured to cover an area where the it is desired that the AFM remain, and has a front edge 608 that is recessed a desired distance from a media facing surface plane indicated by the dashed line denoted MFS. The mask can include a photolithographically patterned photoresist and can also include other materials such as a hard mask an image transfer layer, a bottom anti-reflective coating, etc.

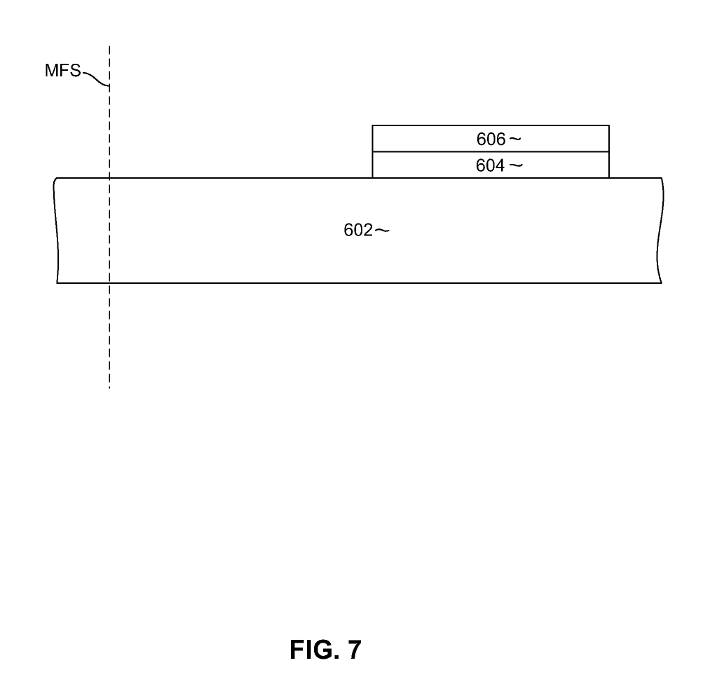

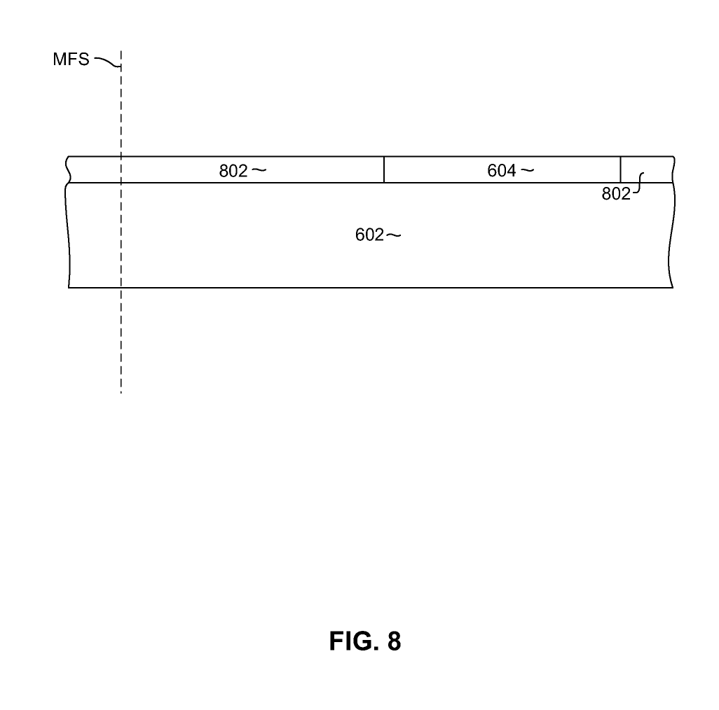

With reference now to FIG. 7, an ion milling process is performed to remove portions of the AFM layer with first part of layer 318a capped with MgO that are not protected by the mask 606. The ion milling can be terminated when the lower main shield portion 602 has been reached. A magnetic shield refill material 802 can then be deposited and a mask liftoff process and planarization process such as chemical mechanical polishing can be performed, leaving a structure such as that shown in FIG. 8 with an AFM structure 604 embedded within a layer of magnetic shield refill material 802. The magnetic shield refill material can be, for example, NiFe. The chemical mechanical polishing can be performed so as to leave a smooth coplanar upper surface for the layers 604, 802.

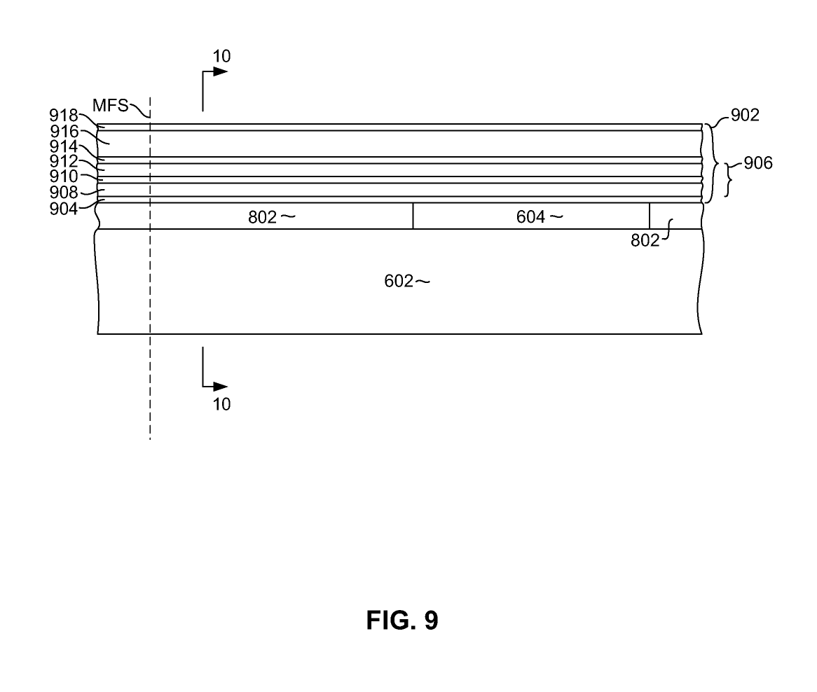

Then, with reference to FIG. 9, a glancing ion mill step is done to remove MgO cap to expose layer 318a then series of sensor layers 902 is deposited full film over the shield fill layer 802 and AFM layer 604 with first part of layer 318a capped with MgO. The series of sensor layers 902 can include: a seed layer 904; a magnetic pinned layer structure deposited over the seed layer 904; a non-magnetic barrier or spacer layer 914 deposited over the pinned layer structure; a magnetic free layer 916 deposited over the non-magnetic barrier or spacer layer 914; and a capping layer 918 deposited over the magnetic free layer. The pinned layer structure can include: a first magnetic layer (AP1) 908 (second part 318b of 318); a non-magnetic anti-parallel coupling layer 910 deposited over the AP1 layer 908; and a second magnetic layer (AP2) deposited over the non-magnetic anti-parallel coupling layer 910.

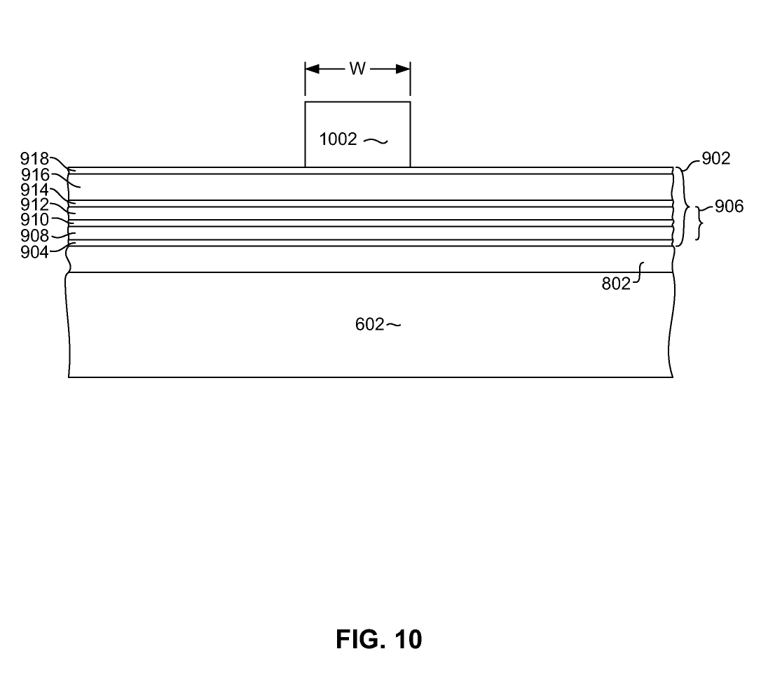

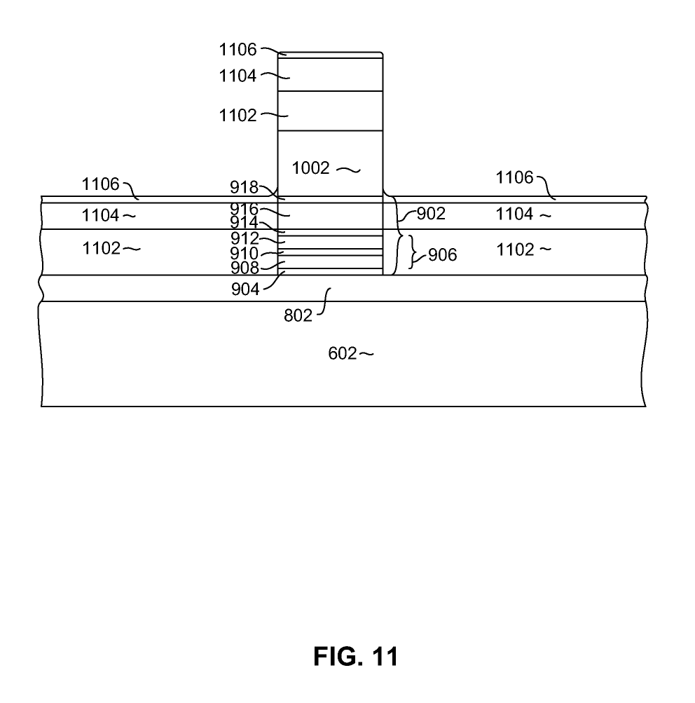

FIG. 10 shows a cross sectional view of a plane parallel with the media facing surface plane, as seen from line 10-10 of FIG. 9. With reference to FIG. 10, a mask 1002 is formed that has a portion with a width W that is configured to define a sensor track width. The mask 1002 may include a photolithographically patterned photoresist, but may also include other layers as well, such as a hard mask, an image transfer layer, a bottom anti-reflective coating, etc. Then, an ion milling is performed to remove portions of the sensor layer material 902 that are not protected by the mask 1002. This ion milling is a full ion milling that can be performed until the shield refill layer 802 has been reached. Then, as shown in FIG. 11, a non-magnetic, electrically insulating fill layer 1102 is deposited followed by a layer of magnetic bias material 1104. A magnetic bias capping layer 1106 can be deposited over the magnetic bias material 1104. The bias capping layer can be a material such as Rh, Ru, or DLC that is resistant to chemical mechanical polishing so that it can function as a chemical mechanical polishing stop layer.

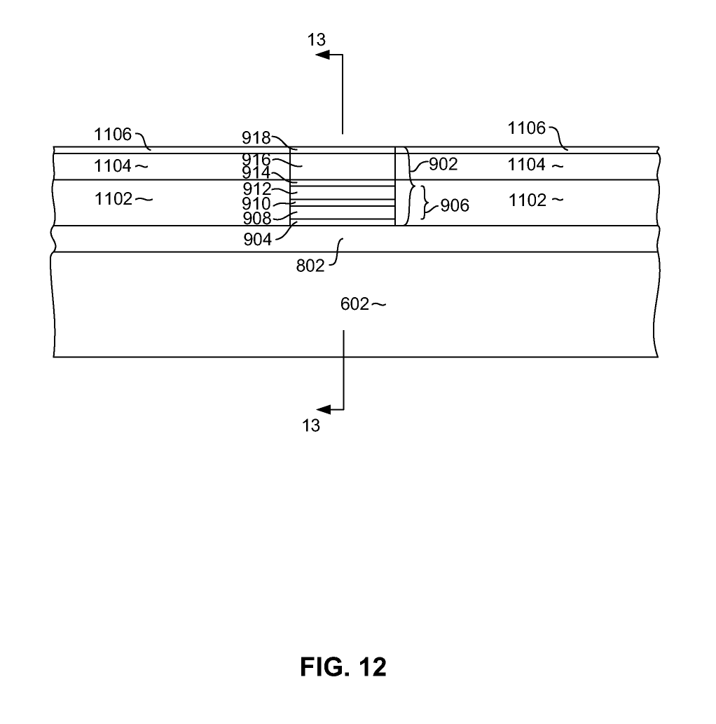

The non-magnetic, electrically insulating fill layer 1102 can be a material such as alumina (Al₂O₃) and is deposited to a thickness such that it extends just up to the level of the non-magnetic spacer or barrier layer 914. In other words, the fill layer 1102 is preferably deposited to a thickness that is about equal to the combined thickness of the pinned layer structure 906, spacer or barrier layer 914, and seed layer 904. This causes the bias layer 1104 to be just located at the level of the magnetic free layer 916 as shown and ensure that the stripe height's ion milling step will mill through the bias layer 1104. The magnetic bias material 1104 can be a soft magnetic bias material such as NiFe, CoFe, or their alloys or could be a hard magnetic bias material CoPt or CoPtCr. A planarization process such as chemical mechanical polishing can then be performed to remove the mask 1102 and form a smooth planar upper surface, thereby leaving a structure as shown in FIG. 12.

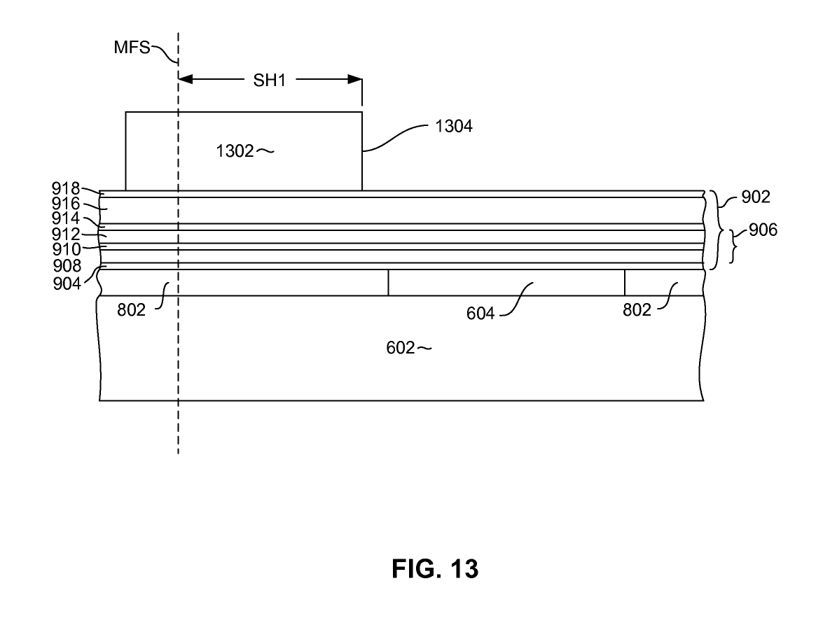

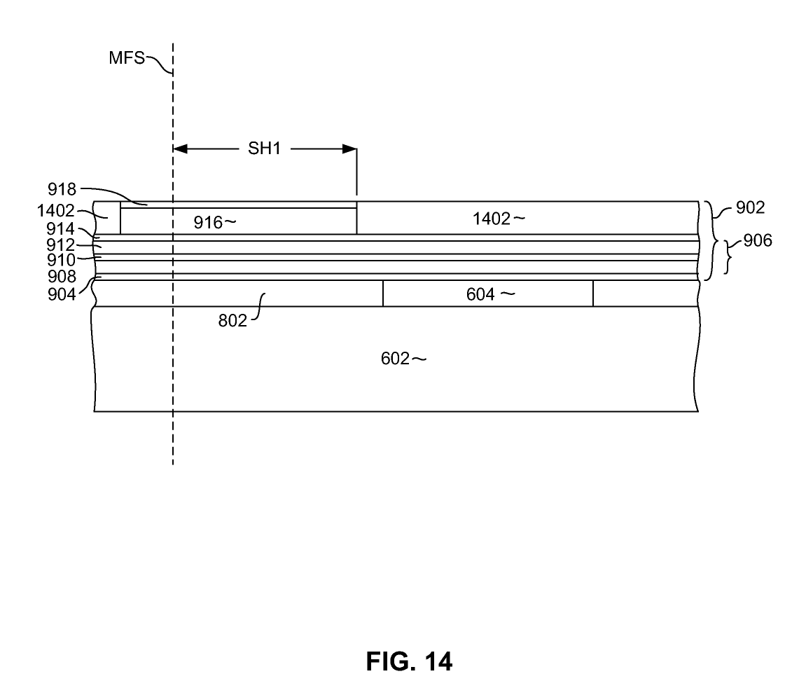

FIG. 13 is a side cross sectional view of a center portion of the magnetic head as seen from line 13-13 of FIG. 12. With reference to FIG. 13, a mask 1302 is formed having a back edge 1304 that is located a desired distance from the media facing surface plane MFS to define a first stripe height. The mask 1302 can include a photolithographically patterned photoresist and can include other layers as well, such as a hard mask, an image transfer layer, a bottom anti-reflective coating, etc. With the mask 1302 thus formed, an ion milling is performed to remove portions of the capping layer 902 and magnetic free layer 916 that are not protected by the mask 1302. The ion milling is terminated either at the non-magnetic barrier/spacer layer 914 or just upon reaching the AP2 layer 912 of the pinned layer structure 906. A non-magnetic, electrically insulating fill layer 1402 such as alumina can then be deposited and a planarization process such as chemical mechanical polishing performed, leaving a structure as shown in FIG. 14.

Because the bias layer 1104 (FIG. 12) is at the same level as the free magnetic layer 916, it can be understood that the ion milling defines both the back edge of the free layer 916, as well as the back edge of the bias layer 1104, and that these layers are self aligned with one another. In addition, this ion milling can define the back edge of the free layer 916 and bias layer 1104, while still leaving the entire pinned layer structure 906 extending further beyond this back edge SH1. If not for the under-lying fill layer 1102, this masking and milling process would not be able to define the back edge of both the free layer 916 and bias layer 1104 without also removing the pinned layer structure 906 in the process.

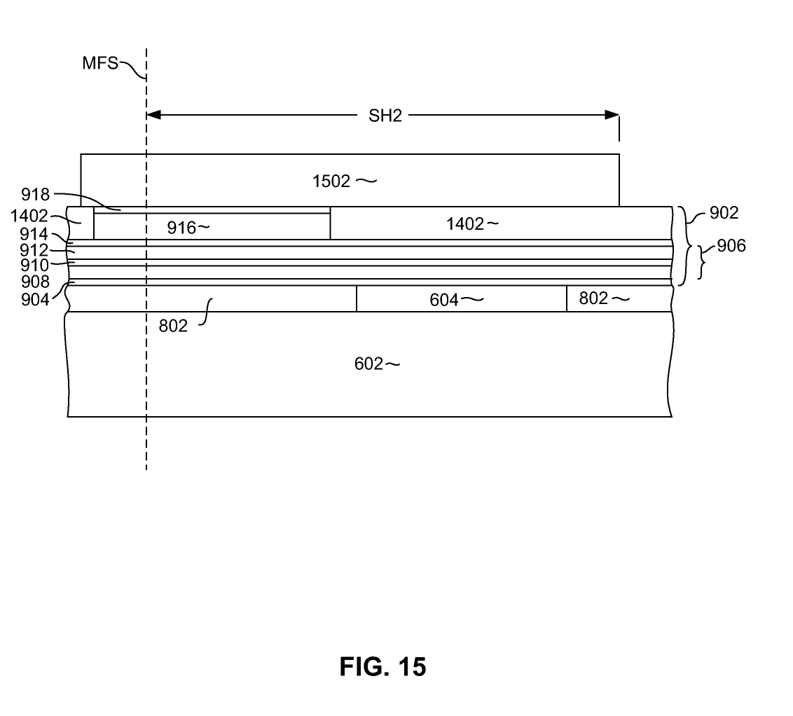

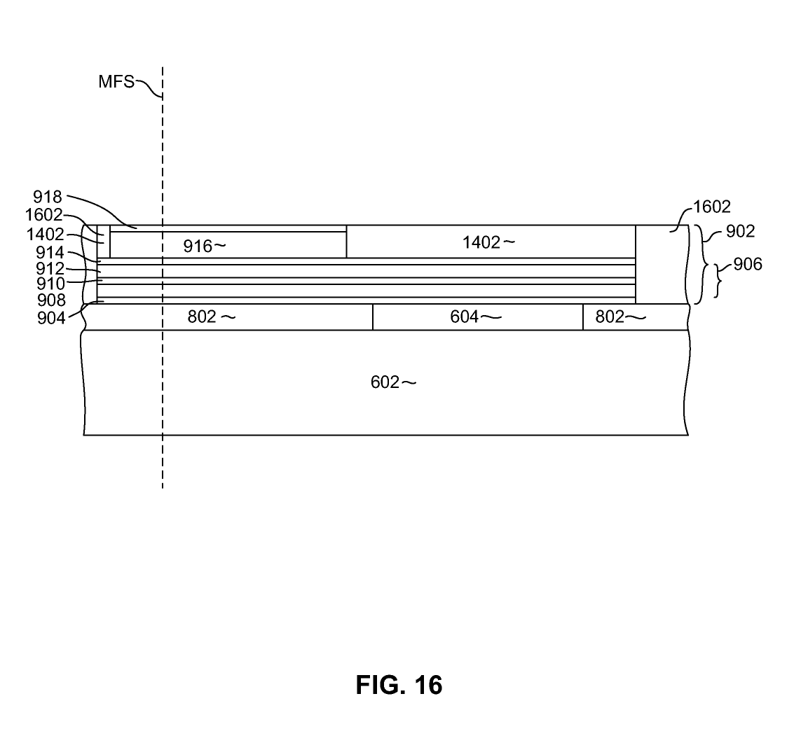

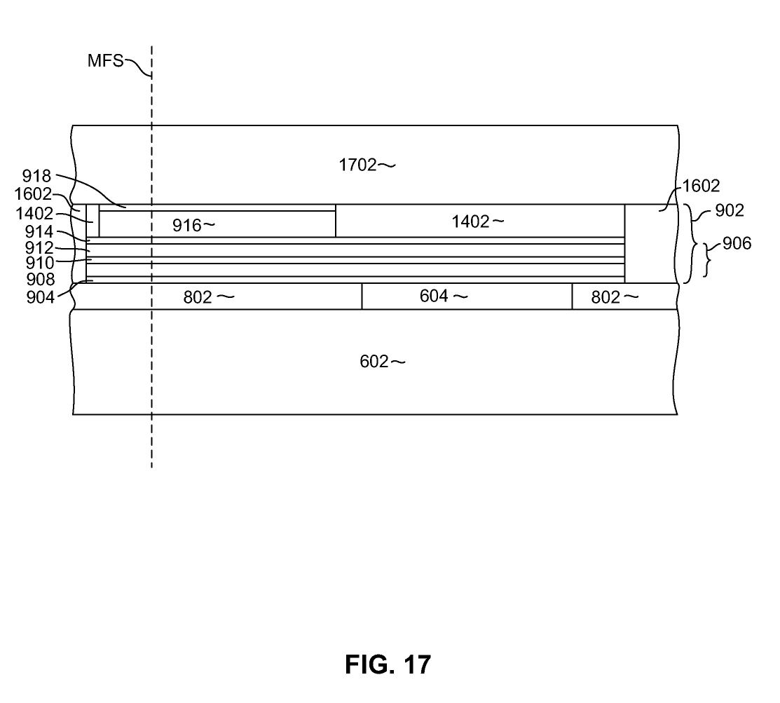

With reference now to FIG. 15, a third mask 1502 can be formed to define the back edge of the pinned layer structure 906, thereby defining a second stripe height SH2. This mask can also define the outer sides of the bias structure 1104 (shown in FIG. 12, but not shown in FIG. 15). An ion milling is then performed to remove portions of the pinned layer structure 906 and fill layer 1402 that are not protected by the mask 1502. Another non-magnetic fill layer such as alumina can then be deposited and another chemical mechanical polishing can be performed, thereby leaving a structure as shown in FIG. 16. Then, with reference to FIG. 17, an upper (or trailing) shield 1702 can be formed, such as by electroplating a magnetic material such as NiFe.

While various embodiments have been described above, it should be understood that they have been presented by way of example only and not limitation. Other embodiments falling within the scope of the invention may also become apparent to those skilled in the art. Thus, the breadth and scope of the invention may also become apparent to those skilled in the art. The breadth and scope of the inventions should not be limited by any of the above-described exemplary embodiments, but should be defined only in accordance with the following claims and their equivalents.

1. A magnetic sensor, comprising:
a free magnetic layer extending to a first stripe height, measured from a media facing surface;
a pinned magnetic layer extending beyond the first stripe height to a second stripe height measured from the media facing surface, wherein the portion of the pinned magnetic layer that extends beyond the first stripe height has a constant width that is the same as a width of the free magnetic layer;
a non-magnetic layer sandwiched between the free magnetic layer and the pinned magnetic layer; and
a magnetic bias structure formed at a side of the free magnetic layer, the bias structure extending to the first stripe height and formed on a non-magnetic fill layer so that the bias structure is aligned with the magnetic free layer.

2. The magnetic sensor as in claim 1, wherein the non-magnetic fill layer has a thickness that is substantially equal to a thickness of the pinned layer structure.

3. The magnetic sensor as in claim 1 further comprising a layer of anti-ferromagnetic material that is exchange coupled with the magnetic pinned layer and that is recessed from the media facing surface.

4. The magnetic sensor as in claim 1, wherein the free layer has a back edge opposite the media facing surface and the magnetic bias structure has a back edge opposite the media facing surface that is aligned with the back edge of the free magnetic layer.

5. The magnetic sensor as in claim 1, wherein magnetic pinned layer has a constant width.

6-7. (canceled)

8. The magnetic sensor as in claim 1, wherein the bias structure terminates at the first stripe height and the non-magnetic fill layer extends beyond the first stripe height.

9. The magnetic sensor as in claim 1, wherein the bias structure is a soft magnetic bias structure.

10. The magnetic sensor as in claim 1, wherein the bias structure is a hard magnetic bias structure.

11. A method for manufacturing a magnetic read sensor, comprising:
depositing a plurality of sensor layers including a magnetic pinned layer structure, a non-magnetic layer deposited over the magnetic pinned layer structure and a magnetic free layer structure deposited over the magnetic pinned layer structure;
forming a first mask having a width configured to define a sensor track width;
performing a first ion milling to remove portions of the plurality of sensor layers that are not protected by the mask;
depositing a non-magnetic, electrically insulating fill layer;
depositing a magnetic bias material over the non-magnetic, electrically insulating fill layer;
forming a second mask configured to define a magnetic free layer stripe height; and
performing a second ion milling to remove portions of the magnetic free layer that are not protected by the second mask, the second ion milling being terminated when prior to removal of the magnetic pinned layer structure.

12. The method as in claim 11, wherein the non-magnetic, electrically insulating fill layer is deposited to a thickness that is at least as great as a thickness of the magnetic pinned layer structure.

13. The method as in claim 11, wherein the non-magnetic, electrically insulating fill layer is deposited to a thickness that is substantially the same as a thickness of the magnetic pinned layer structure.

14. The method as in claim 11, wherein the non-magnetic, electrically insulating fill layer is deposited to a level of the non-magnetic layer deposited over the magnetic pinned layer structure.

15. The method as in claim 11, wherein the second mask has a back edge located a desired distance from a media facing surface plane to define the stripe height.

16. The method as in claim 11, further comprising, after performing the second ion milling:
forming a third mask configured to define a pinned layer stripe height, and
performing an third ion milling to remove portions of the magnetic pinned layer structure that are not protected by the third mask.

17. The method as in claim 11, further comprising, before depositing the plurality of sensor layers, forming an antiferromagnetic layer structure, and wherein the series of magnetic sensor layers are deposited over the antiferromagnetic layer structure.

18. The method as in claim 17 wherein the antiferromagnetic layer structure is embedded in a magnetic material.

19. The method as in claim 17, wherein the antiferromagnetic layer structure is recessed from a media facing surface.

20. The method as in claim 17 wherein the antiferromagnetic layer structure and the magnetic material are formed on a magnetic shield structure.
